(19) United States
(12) Patent Application Publication
(10) Pub. No.: US 2005/0206730 A1
(43) Pub. Date: Sep. 22, 2005

(54) Data input device, information processing device, data input method, and computer product

(75) Inventor: Tatsuo Hagiwara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/909,328

(22) Filed: Aug. 3, 2004

(30) Foreign Application Priority Data
Mar. 19, 2004 (JP) 2004-081196

(51) Int. Cl. H04N 5/225; G06K 9/00; G09G 5/00

(52) U.S. Cl. 348/169; 382/103; 345/168

(57) ABSTRACT

Images of a plurality of keys are projected and it is recognized whether any one of the images of the keys projected is designated by an operator. When the operator designates an image, a controlling unit controls any one of: a position of a boundary between an image of an arbitrary key and an image of a key adjacent to the arbitrary key; a space between an instruction effective area of an image of an arbitrary key and an instruction effective area of an image of a key adjacent to the predetermined; and a size of an outlined arbitrary key image area.

### CROSS-REFERENCE TO RELATED APPLICATIONS

This application is based upon and claims the benefit of priority from the prior Japanese Patent Application No. 2004-081196, filed on Mar. 19, 2004, the entire contents of which are incorporated herein by reference.

### BACKGROUND OF THE INVENTION

1) Field of the Invention

The present invention relates to a technology for creating a virtual keyboard.

2) Description of the Related Art

Generally, input efficiency in operating a personal computer or the like greatly changes depending on whether a keyboard suits with the user's fingers or hands. Therefore, there has been a great need for a keyboard that suits with the hands of any user. Also, there has been a need for a smaller information processing device having small size and better portability. Such a device can be possible if no keyboard is provided.

Japanese Patent Laid-Open Publication No. 2000-89899 discloses a technology that simultaneously satisfies these two needs. In this technology, a virtual keyboard is projected with a laser beam on any flat surface, and the positions of user's fingers are detected with an infrared sensor. Because the keyboard is not a hardware keyboard but is a virtual keyboard, i.e., an image, it can be projected in any size. Japanese Patent Laid-Open Publication No. 7-159192 discloses a technology for freely changing the size of the virtual keyboard.

On the other hand, there has been a demand for freely changing key assignment. For example, there has been a demand for moving the position of the “Ctrl” key from a lower-left corner as in a JIS keyboard to a position at the left of the “A” key as in a familiar keyboard complying with the United States specifications. Also, there has been a demand for using a Dvorak keyboard rather than a Qwerty keyboard. The above patent documents also disclose changing of key assignment on a software basis.

However, in the conventional technology, the positions of the boundary of the keys are fixed, only which function is to be assigned to which key can be changed. Some conventional technologies allow changing the key layouts but only from among preset layouts, so-called “ready-made layout sets”. That is, the conventional technology allows the size of a key on the virtual keyboard to be changed, but merely allows key pitches and the like of all keys to be collectively changed by adjusting a focal length or a projection angle.

Also, as for keyboards, it is more preferable that the size and the position of each key be finely adjusted so as to be suit to the shape of the hands, individuality, or characteristic of each person. Particularly, as for a virtual keyboard projected onto a flat surface, a positional shift on the keyboard cannot be corrected with the feeling by the hands or finger touching the keys. Therefore, a habit of the hands for each person becomes more apparent. That is, in the virtual keyboard, the feeling of the keys cannot be obtained, and therefore a demand for finely adjusting the size and the position of each key might be strong.

However, the conventional technology has a problem that the size and the position of each key cannot be finely adjusted in units of keys for each arbitrary key even though key assignment can be switched. Therefore, the frequency of typing error is disadvantageously increased, thereby making it difficult to achieve quick and accurate inputs.

### SUMMARY OF THE INVENTION

It is an object of the present invention to provide an improved virtual keyboard.

A data input device according to an aspect of the present invention includes a projecting unit that projects images of a plurality of keys; and an instruction recognizing unit that recognizes whether any one of the images of the keys projected by the projecting unit has been designated by an operator; a data input unit that accepts input of data corresponding to the image of the key recognized by the instruction recognizing unit; and a controlling unit. The controlling unit controls any one of a position of a boundary between an image of an arbitrary key and an image of a key adjacent to the arbitrary key projected by the projecting unit; a space between an instruction effective area of an image of an arbitrary key and an instruction effective area of an image of a key adjacent to the arbitrary key projected by the projecting unit; and a size of an outlined arbitrary key image area projected by the projecting unit.

An information processing device according to another aspect of the present invention includes a data input device. The data input device includes a projecting unit that projects images of a plurality of keys; and an instruction recognizing unit that recognizes whether any one of the images of the keys projected by the projecting unit has been designated by an operator; a data input unit that accepts input of data corresponding to the image of the key recognized by the instruction recognizing unit; and a controlling unit. The controlling unit controls any one of a position of a boundary between an image of an arbitrary key and an image of a key adjacent to the arbitrary key projected by the projecting unit; a space between an instruction effective area of an image of an arbitrary key and an instruction effective area of an image of a key adjacent to the arbitrary key projected by the projecting unit; and a size of an outlined arbitrary key image area projected by the projecting unit.

An information processing device according to still another aspect of the present invention includes a data input device. The data input device includes a projecting unit that projects images of a plurality of keys; and an instruction recognizing unit that recognizes whether any one of the images of the keys projected by the projecting unit has been designated by an operator. The information processing device also includes a data input unit that accepts input of data corresponding to the image of the key recognized by the instruction recognizing unit; and a controlling unit. The controlling unit controls any one of a position of a boundary between an image of an arbitrary key and an image of a key adjacent to the arbitrary key projected by the projecting unit; a space between an instruction effective area of an image of an arbitrary key and an instruction effective area of an image of a key adjacent to the arbitrary key projected by the projecting unit; and a size of an outlined arbitrary key image area projected by the projecting unit.

A data input method according to still another aspect of the present invention includes projecting images of a plurality of keys; recognizing whether any one of the images of the keys projected has been designated by an operator; accepting input of data corresponding to the image of the key recognized; and controlling any one of: a position of a boundary between an image of an arbitrary key and an image of a key adjacent to the arbitrary key projected; a space between an instruction effective area of an image of an arbitrary key and an instruction effective area of an image of a key adjacent to the arbitrary key projected; and a size of an outlined arbitrary key image area projected.

A computer program according to still another aspect of the present invention realizes the above method on a computer.

A computer-readable recording medium stores the above computer program.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a data input device according to an embodiment of the present invention;

FIG. 2 is a functional block diagram of the data input device and an information processing device according to the embodiment;

FIG. 3 is a flowchart of a data input method according to the embodiment;

FIG. 4 is another example of flowchart of the data input method according to the embodiment;

FIG. 5 is a flowchart of a process procedure performed by a correction detecting unit, an analyzing unit, and a controlling unit of the data input device or the information processing device according to the embodiment;

FIG. 6 is a diagram for explaining details of a table regarding an input key, an adjacent key, and the number of pressing of a correction key for the adjacent key;

FIG. 7 is a diagram for explaining details of a table regarding a frequency of correction and a moving distance of an adjacent key;

FIGS. 8A through 8E are diagrams for explaining examples of a procedure of changing a key layout;

FIGS. 9A through 9E are diagrams for explaining examples of another procedure of changing a key layout;

FIG. 10 is a diagram for explaining an image of a standard layout of a virtual keyboard;

FIGS. 11 through 14 are diagrams for explaining examples of an image of the changed layout of the virtual keyboard; and

FIG. 15 is a diagram for explaining a relation between the data input device and the information processing device according to the embodiment of the present invention and the virtual keyboard.

### DETAILED DESCRIPTION

Exemplary embodiments of a data input device, an information processing device, a data input method, a computer product according to the present invention are explained below with reference to the accompanying drawings.

Functional Structure of Data Input Device

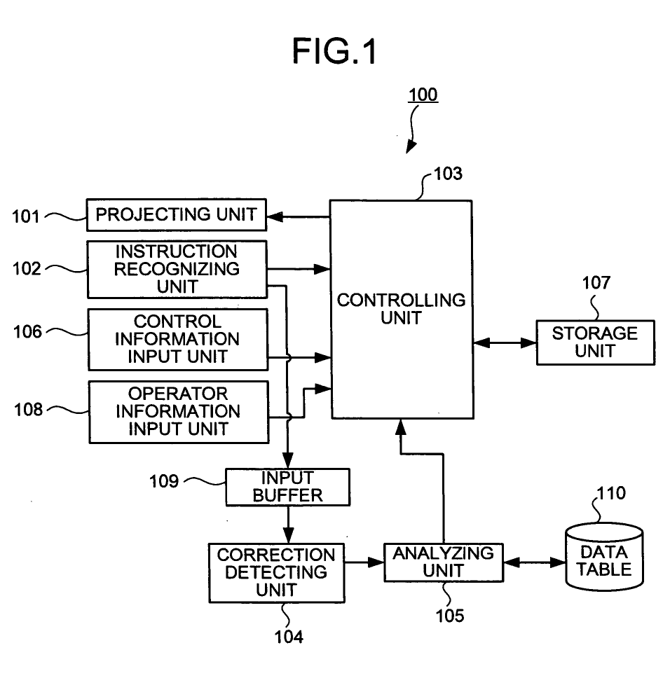

First, a functional structure of a data input device (or information processing device having incorporated therein a data input device) 100 is described below. FIG. 1 is a functional block diagram of a data input device according to an embodiment of the present invention. In FIG. 1, the data input device 100 (or information processing device having incorporated therein a data input device) includes a projecting unit 101, an instruction recognizing unit 102, a controlling unit 103, a correction detecting unit 104, an analyzing unit 105, a control information input unit 106, a storage unit 107, an operator information input unit 108, an input buffer 109, and a data table 110.

The projecting unit 101 projects images of a plurality of keys onto a flat surface, such as a desktop. Specifically, the projecting unit 101 achieves its function by, for example, a semiconductor laser radiation device (semiconductor laser diode).

The instruction recognizing unit 102 recognizes that any one of the images of the keys projected by the projecting unit 101 has been designated and, specifically, achieves its function by, for example, a laser sensor. That is, the laser sensor emits a laser beam over the entire keyboard pattern, and when the laser beam is interrupted by a finger or other substance (a pen or the like), it is recognized that the corresponding key has been pressed. This makes it possible to accept an input of data corresponding to the key image recognized by the instruction recognizing unit 102. Then, the accepted data is input to the input buffer 109, and becomes subjected to correction detection performed by the correction detecting unit 104.

The controlling unit 103 controls a position of a boundary between an image of an arbitrary key and an image of its adjacent key projected by the projecting unit 101. Also, the controlling unit 103 may control a space between an instruction effective area of an image of an arbitrary key and an instruction effective area of an image of a key adjacent to the arbitrary key projected by the projecting unit 101. Furthermore, the controlling unit 103 may control a size of an outlined arbitrary key image area projected by the projecting unit 101.

This makes it possible to change the position of the boundary or outline on a key layout map and its corresponding position of the projected data boundary on a virtual keyboard, thereby adjusting a key layout to be best suited for the shape of a finger or hand or typing habit for each person.

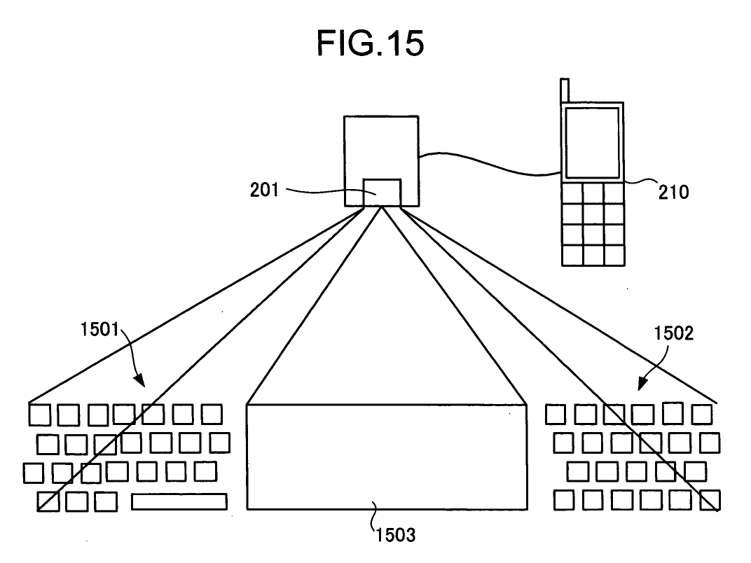

Also, in this case, the controlling unit 103 may perform control such that a key group input by the right hand and a key group input by the left hand projected by the projecting unit 101 are separated from each other and the separated key groups have displayed therebetween an image for display. Details of this will be described further below (refer to FIG. 15).

The correction detecting unit 104 detects a correction of the data recognized by the instruction recognizing unit 102. Based on the detection results obtained by the correction detecting unit 104, the analyzing unit 105 analyzes the input state of the operator, and rewrites and stores information on the data table 110 regarding the analyzed input state when appropriate. That is, the frequency is stored in the data table 110 for each retyping pattern.

At this time, based on the analysis results obtained by the analyzing unit 105, the controlling unit 103 controls a position of a boundary between a projected image of an arbitrary key and a projected image of a key adjacent to the arbitrary key, a space between an instruction effective area of an image of an arbitrary key and an instruction effective area of an image of a key adjacent to the arbitrary key projected by the projecting unit 101, or a size of an outlined arbitrary key image area projected by the projecting unit 101.

This makes it possible to monitor a typing error at normal key input and analyze a typing habit even though which type of the key layout is most suitable for the operator is not known at first. As a result of analysis, if it is determined that a key adjacent to a correct key tends to be erroneously typed, a boundary or space on the key map can be slightly changed so as to reduce the frequency of such typing error. Therefore, a key layout best suited to each operator can be achieved.

The controlling unit 103, the correction detecting unit 104, and the analyzing unit 105 achieve their respective function by a CPU (not shown) executing a program stored in a ROM, RAM, hard disk, or the like (not shown).

The control information input unit 106 accepts an input of information regarding the position of the boundary between the projected image of the arbitrary key and the image of the key adjacent to the arbitrary key, information regarding the space between the instruction effective area of the image of the arbitrary key and the instruction effective area of the image of the key adjacent to the arbitrary key projected by the projecting unit 101, or information regarding the size of the outlined arbitrary key image area projected by the projecting unit 101.

At this time, based on the information input by the control information input unit 106, the controlling unit 103 controls the position of the boundary between the projected image of the arbitrary key and the image of the key adjacent to the arbitrary key, the space between the instruction effective area of the image of the arbitrary key and the instruction effective area of the image of the key adjacent to the arbitrary key projected by the projecting unit 101, or the size of the outlined arbitrary key image area projected by the projecting unit 101.

The storage unit 107 stores information regarding the position of the boundary between the projected image of the arbitrary key and the image of the key adjacent to the arbitrary key, information regarding the space between the instruction effective area of the image of the arbitrary key and the instruction effective area of the image of the key adjacent to the arbitrary key projected by the projecting unit 101, or information regarding the size of the outlined arbitrary key image area projected by the projecting unit 101.

Specifically, the storage unit 107 achieves its function by a RAM or HD not shown. At this time, based on the information stored by the storage unit 107, the controlling unit 103 controls the position of the boundary between the projected image of the arbitrary key and the image of the key adjacent to the arbitrary key, the space between the instruction effective area of the image of the arbitrary key and the instruction effective area of the image of the key adjacent to the arbitrary key projected by the projecting unit 101, or the size of the outlined arbitrary key image area projected by the projecting unit 101.

The operator information input unit 108 accepts an input of information regarding the operator. At this time, based on the information input by the operator information input unit 108, the controlling unit 103 extracts the information stored by the storage unit 107. Then, based on the extracted information, the controlling unit 103 controls the position of the boundary between the projected image of the arbitrary key and the image of the key adjacent to the arbitrary key, the space between the instruction effective area of the image of the arbitrary key and the instruction effective area of the image of the key adjacent to the arbitrary key projected by the projecting unit 101, or the size of the outlined arbitrary key image area projected by the projecting unit 101.

Functional Structure of Information Processing Device

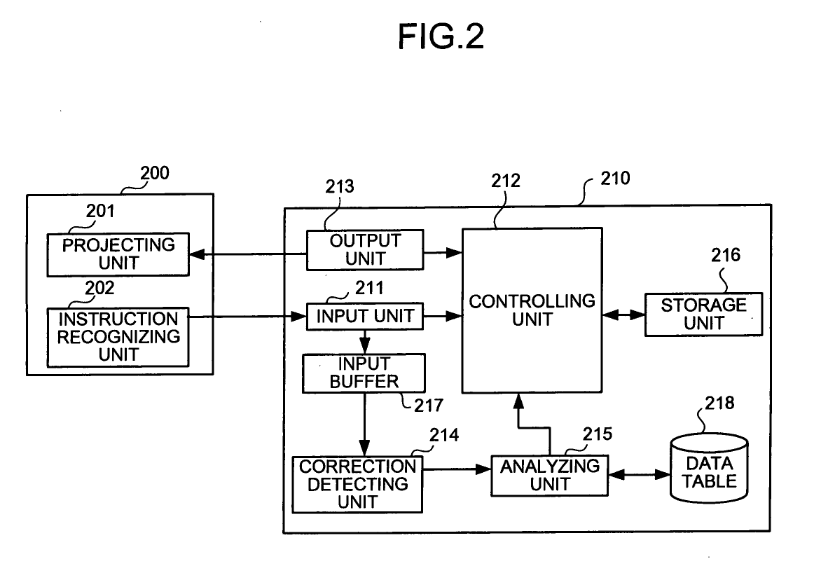

Next, functional structures of a data input device 200 and an information processing device 210 connected to the data input device 200 are described below. FIG. 2 is a functional block diagram of the data input device and the information processing device according to the embodiment. In FIG. 2, the data input device 200 includes a projecting unit 201 and an instruction recognizing unit 202. The projecting unit 201 and the instruction recognizing unit 202 are similar in structure to the projecting unit 101 and the instruction recognizing unit 102 shown in FIG. 1, and therefore are not described herein.

Specifically, the information processing device 210 is generally a portable information processing terminal, such as a cellular phone or PDA terminal, without a full keyboard. However, this is not meant to be restrictive. This information processing device 210 includes an input unit 211, a controlling unit 212, an output unit 213, a correction detecting unit 214, an analyzing unit 215, a storage unit 216, an input buffer 217, and a data table 218. Here, the controlling unit 212, the correction detecting unit 214, the analyzing unit 215, the storage unit 216, the input buffer 217, and the data table 218 are similar in structure to the controlling unit 103, the correction detecting unit 104, the analyzing unit 105, the storage unit 107, the input buffer 109, and the data table 110 shown in FIG. 1, and therefore are not described herein.

The input unit 211 accepts an input of data corresponding to the image of the key recognized by the instruction recognizing unit 202 of the data input device 200. Then, the accepted data is input to the input buffer 217, and becomes subjected to correction detection performed by the correction detecting unit 214.

The output unit 213 outputs information regarding the image controlled by the controlling unit 212 to the projecting unit 201 of the data input device 200. The input unit 211 achieves its function by a digitizer, such as a mouse. In this case, a boundary or outline of a key may be dragged to change the boundary or outline. This makes it possible to control the information regarding the setting of the keyboard from the information processing device body side.

In this manner, the data input device 200 is connected to the information processing device 210, and includes only the projecting unit 201 and the instruction recognizing unit 202. The other components, that is, the controlling unit 212, the correction detecting unit 214, the analyzing unit 215, and the storage unit 216, may be provided to the information processing device 210 side.

Data Input Method

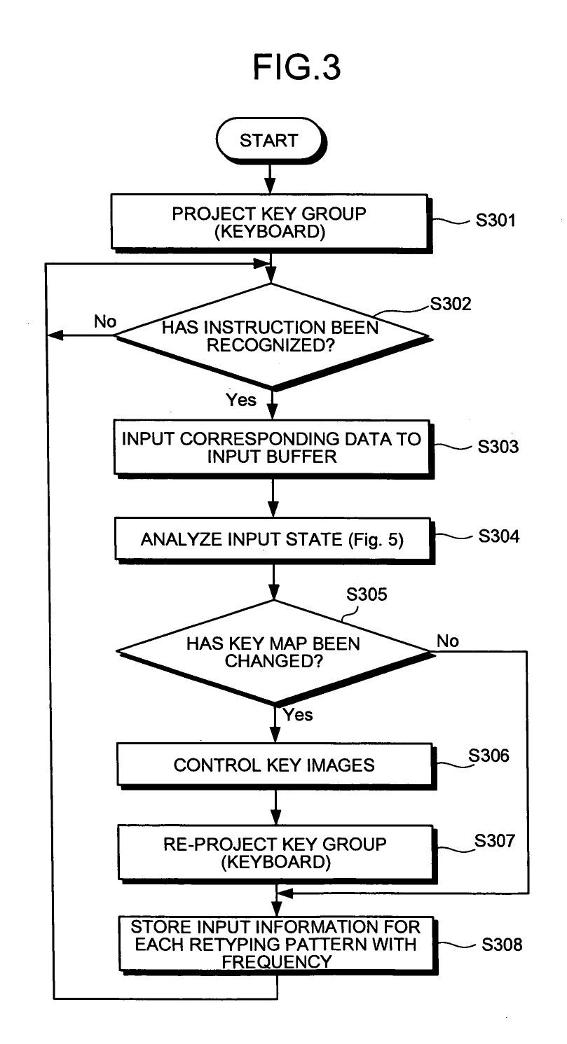

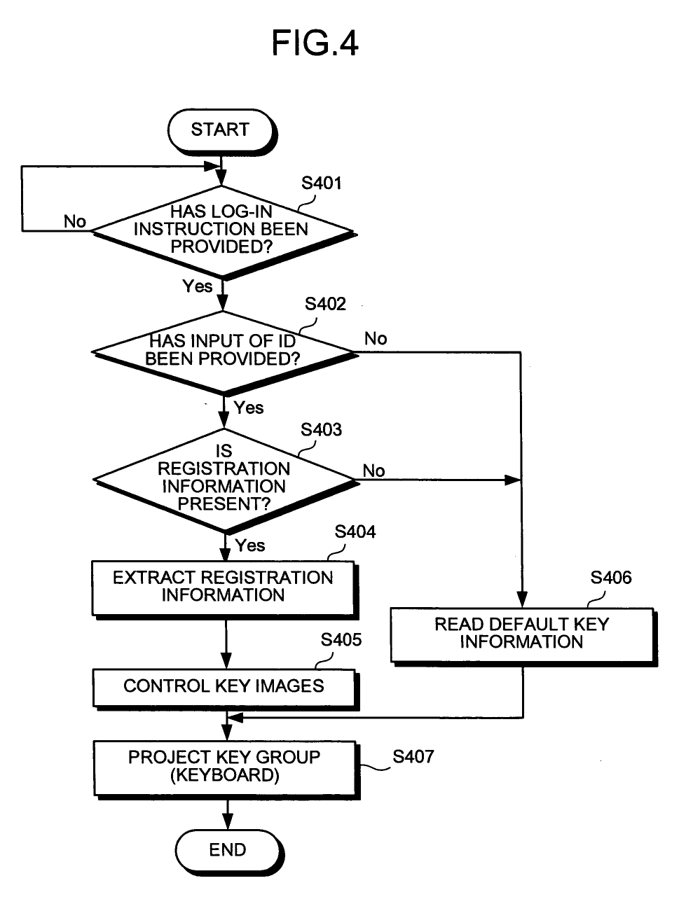

FIGS. 3 and 4 are flowcharts of the procedure of a data input method according to the embodiment of the present invention. In the flowchart of FIG. 3, first, a key group (keyboard) is projected (step S301). It is then determined whether an instruction has been recognized, that is, whether it is detected that an arbitrary key on the projected keyboard has been pressed (step S302).

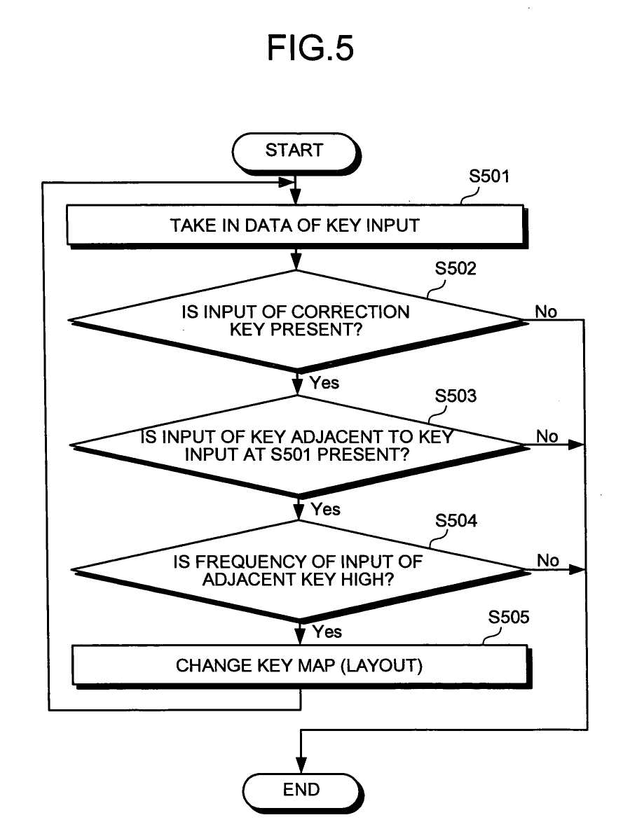

Here, if an instruction is waited for and is then recognized (step S302: Yes), an input of data of a key corresponding to the recognized instruction is accepted, and the data is then input to the input buffer 109 or 217 (step S303). Then, the input state is analyzed (step S304). Details on analysis of the input state will be described further below (refer to FIG. 5).

Next, it is determined whether a key map has been changed (step S305). Here, if the key map has not been changed (step S305: No), the procedure goes to step S308. On the other hand, if the key map has been changed (step S305: Yes), based on the analysis results or the input control information, the image of the key is controlled (step S306). Details of this control will be described further below. Then, the key group (keyboard) including the controlled key image is re-projected (step S307), and the procedure then goes to step S308.

At step S308, the input information is stored for each retyping pattern with its frequency, and the procedure then returns to step S302. Thereafter, the processes at steps S302 through S308 are repeatedly performed. Alternatively, step S308 may be performed after step S303 or step S304.

FIG. 4 is a flowchart of another procedure of the data input method according to the embodiment of the present invention, and depicts a process of arranging keys at the time of log-in. In the flowchart of FIG. 4, it is determined whether a log-in instruction has been provided by the operator to the information processing device (step S401). Then, it is determined whether an input of an ID from the operator has been provided (step S402).

At step S402, if no input of the ID is present (step S402: No), default keys are read (step S406), a normal key group (keyboard) is projected (step S407), and then the series of process ends. On the other hand, if an input of the ID is present (step S402: Yes), it is then determined whether registration information regarding an image of a key registered corresponding to the input ID is present (step S403). When no registration information is present (step S403: No), the default keys are read (step S406), the normal key group (keyboard) is projected (step S407), and then the series of processes ends.

On the other hand, if registration information is present at step S403 (step S403: Yes), the registration information is extracted (step S404) and, based on the extracted registration information, the image of the key is controlled (step S405). Based on the results obtained through control, a key group (keyboard) is projected (step S407), and then the series of processes ends.

With this, a virtual keyboard suited to each log-in operator can be projected at the time of log-in.

Correction Detecting Unit, Analyzing Unit, and Controlling Unit

Next, the procedure of processes to be performed by the correction detecting unit 104, the analyzing unit 105, and the controlling unit 103 of the data input device 100 or the correction detecting unit 214, the analyzing unit 215, and the controlling unit 212 of the information processing device 210 is described below. FIG. 5 is a flowchart of a procedure of processes to be performed by the correction detecting unit, the analyzing unit, and the controlling unit of the data input device or the information processing device according to the embodiment of the present invention, and depicts a process of detecting an erroneous input and changing a layout of an arbitrary key based on the detection results.

In the flowchart of FIG. 5, firstly, data of a key input is taken in (step S501). Then, it is determined whether an input of a correction key is present in the taken-in data (step S502). Specifically, the correction key is any one of, for example, a “Delete” key, “Insert” key, “Backspace” key, arrow keys (“↑”, “→”, “←”, “↓”), and a space key.

At step S502, if no input of a correction key is present (step S502: No), the series of processes ends. On the other hand, if an input of a correction key is present (step S502: Yes), it is determined whether an input of a key adjacent to the key input at step S501 is present (step S503). For example, if the input key is “S”, the adjacent key is any one of “W”, “A”, “Z”, “X”, “D”, and “E”.

At step S503, if no input of the adjacent key is present (step S503: No), the series of processes ends. On the other hand, if an input of the adjacent key is present (step S503: Yes), it is determined whether the frequency of input of the adjacent key is high (step S504). Here, whether the input frequency is high is determined by determining whether the input frequency is larger than a predetermined threshold. Also, the predetermined threshold can be arbitrarily changed.

At step S504, if the frequency of input of the adjacent key is smaller than the threshold (step S504: No), the series of processes ends. On the other hand, if the frequency of input of the adjacent key is larger than the threshold (step S504: Yes), the key map (layout) is changed (step S505), and the procedure then returns to step S501. Thereafter, the processes of steps S501 through S505 are repeatedly performed.

Data Table

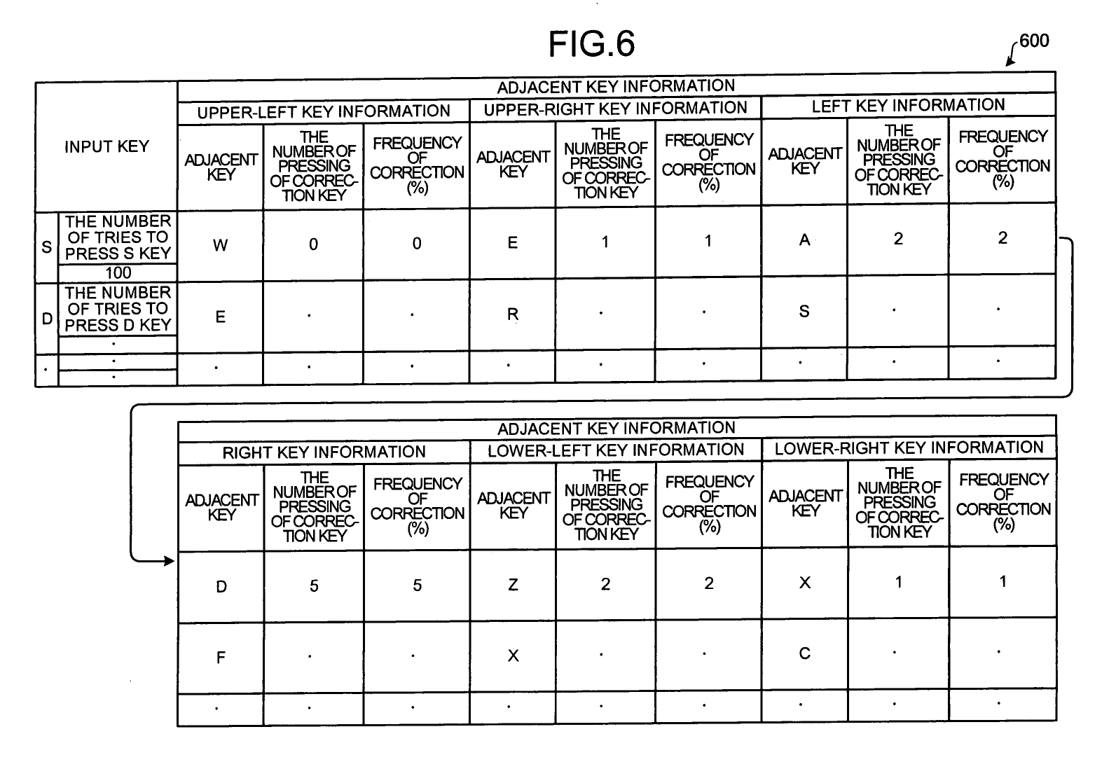

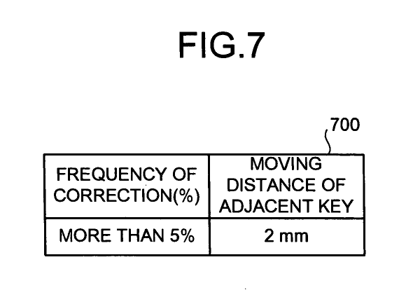

Next, an internal structure of the data table 110 or 218 is described below. FIG. 6 is a diagram for explaining details of a table regarding an input key, an adjacent key, and the number of pressing of a correction key for the adjacent key. FIG. 7 is a diagram for explaining details of a table regarding the frequency of correction and a moving distance of an adjacent key.

The data table 110 or 218 has stored therein data required for analyzing the frequency, and has specifically stored therein, for example, a table 600 shown in FIG. 6 regarding the input key, the adjacent key, and the number of pressing of a correction key for the adjacent key and a table 700 shown in FIG. 7 regarding the frequency of correction and the moving distance of the adjacent key. Here, the adjacent key is a key pressed immediately before pressing a correction key, and the input key is a key pressed immediately after pressing a correction key.

In the table 600 shown in FIG. 6, “the number of tries to press S key” represents (the number of actually pressing the S key)-(the number of erases of S input by the delete key or the like). Also, a “frequency of correction (percent)” represents (the number of pressing of a correction key after pressing the adjacent key)/(the number of tries to press the S key). Furthermore, in the table 700 shown in FIG. 7, a “frequency of correction” and a “moving distance of adjacent key” can be changed.

The frequency of correction by a correction key is analyzed at the following timing. That is, assuming that “A key input”→“B key input”→“C key input”→“D key input (erroneous input)”→“correction key input”→“S key input (correct input)”, → . . . , a key input that is one key input before the correction key input is determined as an “erroneous input” and a key input that is one key input after the correction key is determined as a “correct input”. The information described above (input history) is stored in the data table 110 or 218. If the frequency of correction is larger than a predetermined value, the position of the adjacent key is moved. In some cases, a plurality of characters are input, and then correction is performed. In such cases, the number of pressing of the “←” key or the delete key may be counted, and then the corrected character may be specified for determination.

More specifically, for example, if the “S” key is supposed to be input but its adjacent “D” key is erroneously pressed instead, a correction key is input at the time of the input of the “D” key. Then, the number of pressing of the correction key is counted. Next, the correct “S” key is inputted. Then, the number of pressing of the correction key of the “D” key adjacent to the “S” key becomes “1”.

Thereafter, the number of pressing of the correction key is monitored. If the number of tries to press the “S” key is higher than a predetermined number (for example, one hundred), and the frequency of correction exceeds 5 percent, for example, the adjacent “D” key is moved rightward by a moving distance (2 millimeters) according to the table 700 shown in FIG. 7.

In this manner, data items required for analyzing the frequency include, for example, the number of tries to press each key, the number of pressing of the correction key for each adjacent key in the tables for each input key and its adjacent key. The data items further include the moving distance of the adjacent key corresponding to the frequency of correction.

Changing Key Layout

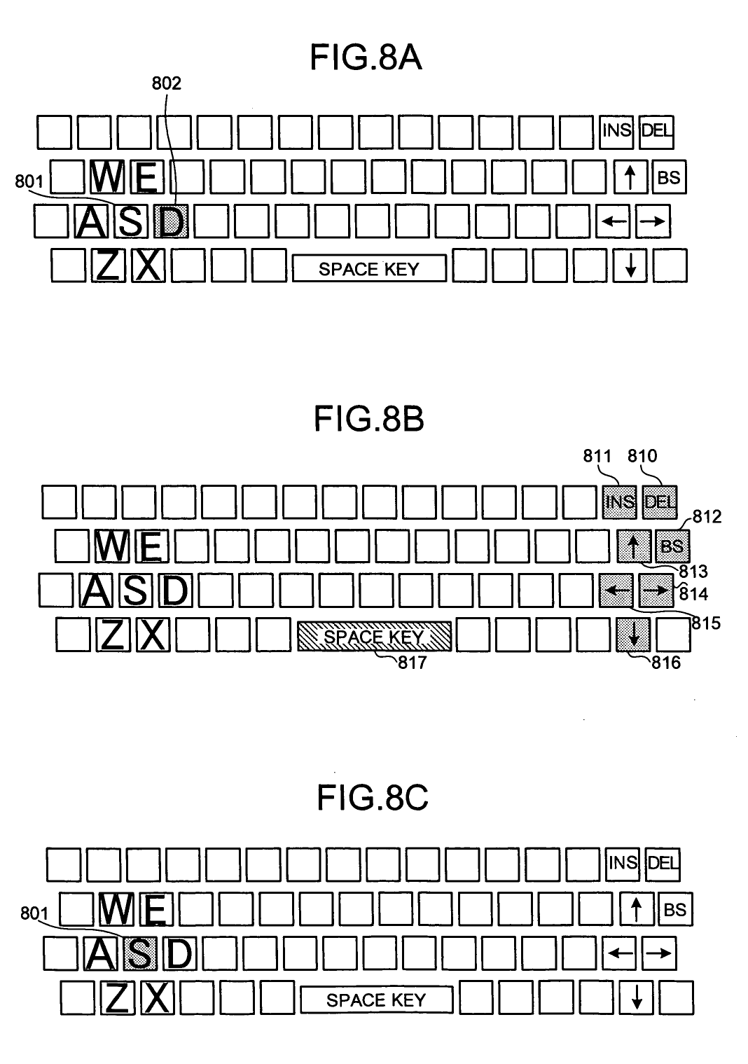

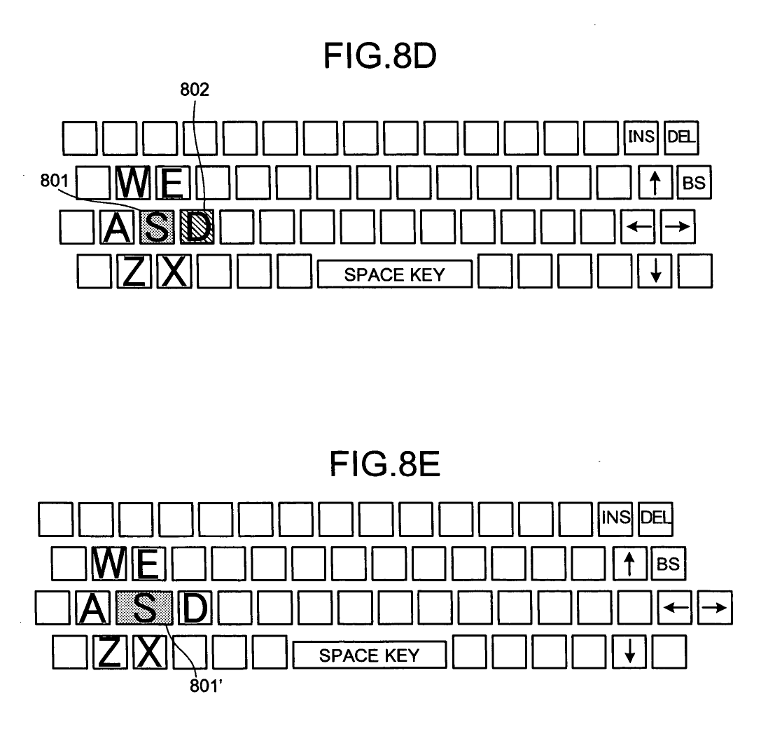

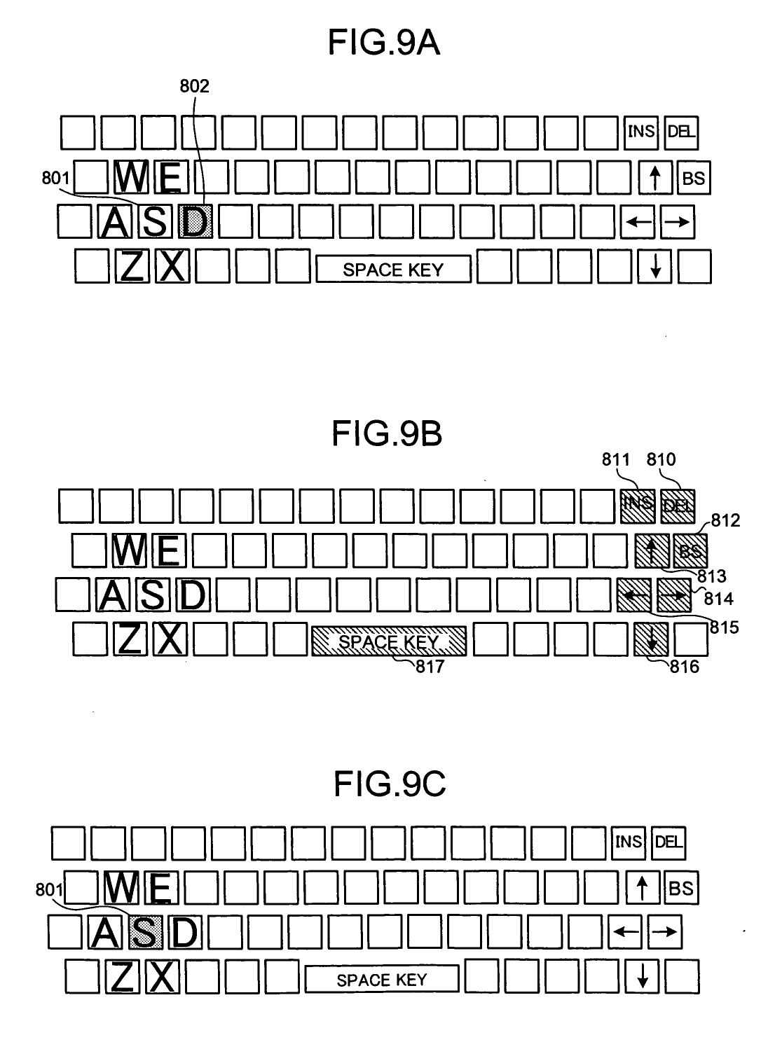

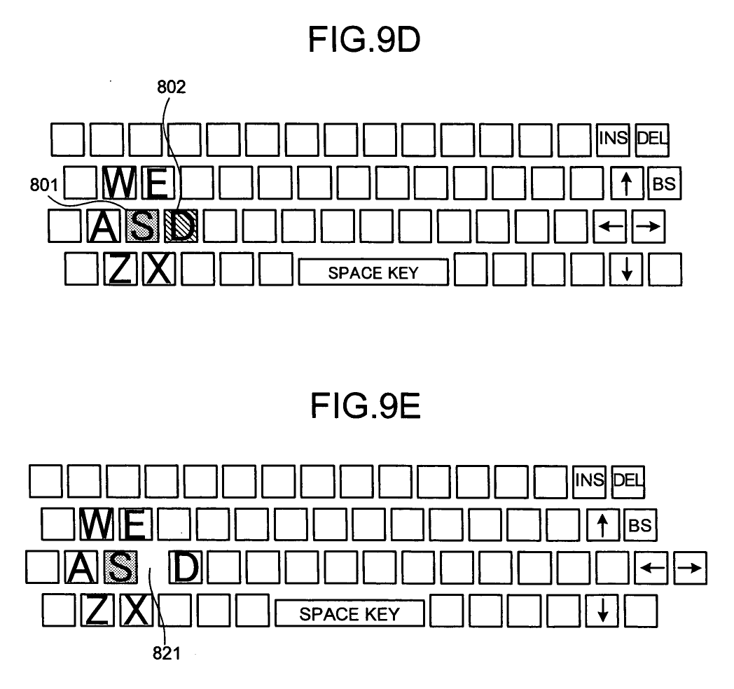

Next, a specific procedure of changing the key layout is described below. FIGS. 8A through 8E and FIGS. 9A through 9E are diagrams for explaining examples of the procedure of changing the key layout, assuming that an “S” key 801 is supposed to be input but its adjacent “D” key 802 is erroneously pressed instead.

In FIGS. 8A and 9A, if an “S” key 801 is supposed to be input but its adjacent “D” key 802 is erroneously pressed instead, the input information is taken out. FIGS. 8A and 9A depict the state where the “D” key 802 is erroneously pressed. Next, it is determined whether any correction key, specifically, any one of a “Delete” key 810, an “Insert” key 811, a “Backspace” key 812, a “↑” key 813, a “→” key 814, a “←” key 815, a “↓” key 816, and a space key 817, has been input. FIGS. 8B and 9B depicts the state where any one of the correction keys has been input.

Furthermore, it is determined whether the correct “S” key 801 adjacent to the “D” key 802 has been correctly input. FIGS. 8C and 9C depict the state where the correct “S” key 801 adjacent to the “D” key 802 has been correctly input.

Then, the frequency of input of the adjacent key is analyzed. That is, after the “D” key 802 is input, the correction key is input, and then the frequency of input of the “S” key 801 adjacent to the “D” key 802 is counted (FIGS. 8D and 9D).

Then, the key map (layout) is changed. FIG. 8E depicts an image after change. Specifically, to reduce the frequency of failing to type a key that is supposed to be typed, the key size of the “S” key 801 is extended rightward (that is, in the direction of the “D” key 802) by a predetermined amount to form a new “S” key 801′.

FIG. 9E depicts another image after change. Specifically, to reduce the frequency of failing to type a key that is supposed to be typed, a key group arranged at the right side of the “D” key 802 adjacent to the “S” key 801 is shifted rightward (that is, in a direction reverse to the position where the “S” key 801 is located), thereby forming a space 821 between the “S” key 801 and the “D” key 802.

(Image of Changed Layout)

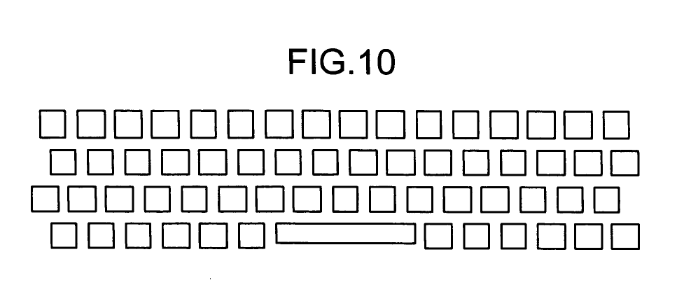

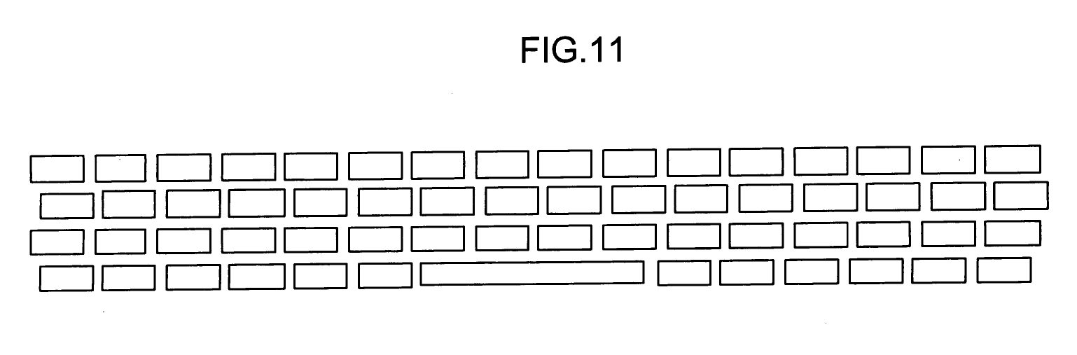

Next, an image of the changed layout of the virtual keyboard is described below. FIG. 10 is a diagram for explaining an image of a standard layout of the virtual keyboard. FIGS. 11 through 14 are diagrams for explaining examples of an image of the changed layout of the virtual keyboard.

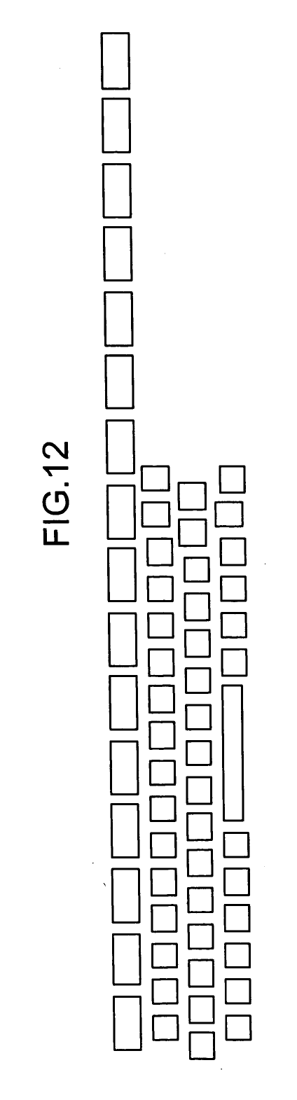

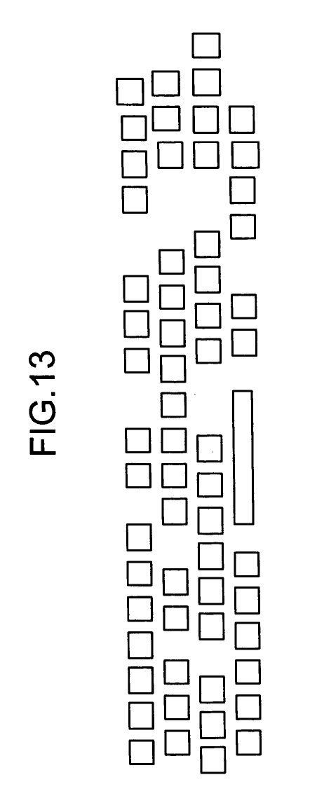

FIG. 11 depicts the case where the key size of the keyboard is increased compared with the standard layout shown in FIG. 10. FIG. 12 depicts the case where only the key size of keys at the highest row are increased. Here, although not shown, only the key size of keys at the highest row may be decreased. FIG. 13 depicts the case where some spaces each formed between one key and its adjacent key are increased compared with the standard layout shown in FIG. 10.

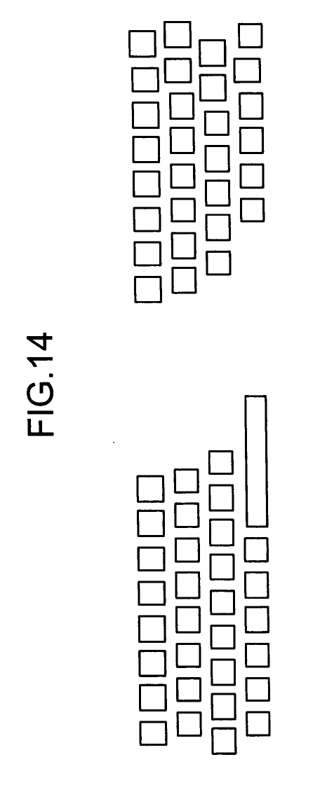

Further, FIG. 14 depicts the case where the keyboard is divided into two with reference to a predetermined boundary (for example, a boundary between keys input by the left hand and keys input by the right hand), compared with the standard layout shown in FIG. 10 FIG. 15 is a diagram for explaining a relation between the data input device and the information processing device according to the embodiment of the present invention and the virtual keyboard and, particularly depicts the case where the keyboard is divided into two with reference to the keys input by the left hand and the keys input by the right hand. In FIG. 15, to project a left-hand virtual keyboard 1501 and a right-hand virtual keyboard 1502, two semiconductor laser projecting devices are provided, one being dedicated to the left-hand virtual keyboard 1501 and the other being dedicated to the right-hand virtual keyboard 1502.

Furthermore, in FIG. 15, the separated left-hand virtual keyboard 1501 and the right-hand virtual keyboard 1502 have provided therebetween a virtual display 1503. That is, an image is projected for display between the left-hand virtual keyboard 1501 and the right-hand virtual keyboard 1502.

This eliminates the need for providing a display device at the data input device 100 or 200 or the information processing device 210 side, thereby reducing the size and weight of the entire device and improving portability. Furthermore, when data input is performed by using a virtual keyboard, it is difficult to perform a blind-touch operation because the virtual keyboard does not have a feeling of keys. Therefore, the operator has to view the projected virtual keyboard for input. In the layout shown in FIG. 15, the keyboard and the display are displayed on the same plane, thereby reducing the amount of movement of the eyes compared with conventional device separately provided with a display and also achieving more efficient data input.

Also, with the operation of narrowing a space between the left-hand virtual keyboard 1501 and the right-hand virtual keyboard 1502 that are separately provided (for example, when an arbitrary key is not pressed or no key input has been present for a predetermined period), the space between the left-hand virtual keyboard 1501 and the right-hand virtual keyboard 1502 that are separately provided is narrowed, thereby allowing the virtual display 1503 to be hidden. This can prohibit the image displayed on the display from being viewed by others.

Thus, according to the present embodiment, the projecting unit 101 or 201 projects images of keys. The instruction recognizing unit 102 or 202 recognizes that any of the key images projected by the projecting unit 101 or 201 has been designated. When accepting an input of data corresponding to the image of the key recognized by the instruction recognizing unit 102 or 202, the controlling unit 103 or 212 controls a position of a boundary between a image of an arbitrary key and a projected image of a key adjacent to the arbitrary key projected by the projecting unit 101 or 201, a space between an instruction effective area of an image of an arbitrary key and an instruction effective area of an image of a key adjacent to the arbitrary key projected by the projecting unit 101, or a size of an outlined arbitrary key image area projected by the projecting unit 101. Therefore, the key map can be set at a position best suited to each individuality, such as a typing habit or a skeletal frame of the hands of each operator. This makes it possible to reduce the frequency of typing error, and also to perform quick and accurate inputs, thereby achieving efficient input processing.

Furthermore, the correction detecting unit 104 or 214 detects a correction of data recognized by the instruction recognizing unit 102 or 202. Based on the detection results obtained by the correction detecting unit 104 or 214, the analyzing unit 105 or 215 analyzes the input state of the operator. Therefore, the key layout can be automatically changed, thereby allowing the operator to be unaware of the change of the key layout.

Moreover, the control information input unit 106 accepts, from the operator, an input of information regarding a position of the key boundary, a space between keys, or the size of a key. Based on the information input by the control information input unit 106, the controlling unit 103 controls the position of the key boundary, the space between keys, or the size of the key. Therefore, a key layout desired by the operator can be easily achieved.

Furthermore, the storage unit 107 stores the information regarding the position of the key boundary, the space between keys, or the size of the key. Based on the information stored by the storage unit 107, the controlling unit 103 controls the position of the key boundary, the space between keys, or the size of the key. Therefore, the key layout once set can be easily changed later.

Moreover, the operator information input unit 108 accepts an input of information regarding the operator, such as the ID of the operator. Based on the information input by the operator information input unit 108, the controlling unit 103 extracts the information stored by the storage unit 107 and, based on the extracted information, controls the position of the key boundary, the space between keys, or the size of the key. Therefore, at the time of log-in to the information processing device with the ID, the operator can automatically use a keyboard setting and a key map suited to the preferences of the operator.

In the data input method described here can be achieved by a computer, such as a personal computer or work station, executing a previously-provided program. This program is recorded on a computer-readable recording medium, such as a hard disk, flexible disk, CD-ROM, MO, or DVD, and is read from the recording medium by the computer for execution. Also, the program may be a transmission medium that can be distributed over a network, such as the Internet.

According to the present invention, an optimal key layout is easily achieved for each operator, thereby reducing the frequency of typing error and achieving quick and accurate inputs. This achieves an effect of obtaining a data input device, an information processing device, a data input method, a data input program, and a computer-readable recording medium having stored therein the data input program that allow efficient input processing.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A data input device comprising:
a projecting unit that projects images of a plurality of keys;
an instruction recognizing unit that recognizes whether any one of the images of the keys projected by the projecting unit has been designated by an operator;
a data input unit that accepts input of data corresponding to the image of the key recognized by the instruction recognizing unit; and
a controlling unit that controls any one of
a position of a boundary between an image of an arbitrary key and an image of a key adjacent to the arbitrary key projected by the projecting unit;
a space between an instruction effective area of an image of an arbitrary key and an instruction effective area of an image of a key adjacent to the arbitrary key projected by the projecting unit; and
a size of an outlined arbitrary key image area projected by the projecting unit.

2. The data input device according to claim 1, further comprising:
a correction data detecting unit that detects correction of the data recognized by the instruction recognizing unit; and
an analyzing unit that analyzes an input state of the operator based on detection results obtained by the correction detecting unit, wherein
the controlling unit controls any one of the position of the boundary, the space, and the size based on the results obtained by the analyzing unit.

3. The data input device according to claim 1, further comprising a control information input unit that accepts an input of information regarding any one of the position of the boundary, the space, and the size, wherein
the controlling unit controls any one of the position of the boundary, the space, and the size based on the information input by the control information input unit.

4. The data input device according to claim 1, further comprising:
a storage unit that stores information regarding a state in which any one of the position of the boundary, the space, and the size has been controlled by the controlling unit, wherein
the controlling unit controls any one of the position of the boundary, the space, and the size based on the information stored by the storage unit.

5. The data input device according to claim 4, further comprising:
an operator information input unit that accepts information regarding the operator, wherein
the controlling unit extracts, based on the information input by the operator information input unit, the information stored by the storage unit, and controls any one of the position of the boundary, the space, and the size based on the information extracted.

6. The data input device according to claim 1, wherein
the controlling unit controls such that a right-key group input by a right hand and a left-key group input by a left hand of the operators projected by the projecting unit are separated from each other in such a manner that information can be displayed in a space between the right-key group and the left-key group.

7. An information processing device comprising a data input device, the data input device including
a projecting unit that projects images of a plurality of keys;
an instruction recognizing unit that recognizes whether any one of the images of the keys projected by the projecting unit has been designated by an operator;
a data input unit that accepts input of data corresponding to the image of the key recognized by the instruction recognizing unit; and
a controlling unit that controls any one of
a position of a boundary between an image of an arbitrary key and an image of a key adjacent to the arbitrary key projected by the projecting unit;
a space between an instruction effective area of an image of an arbitrary key and an instruction effective area of an image of a key adjacent to the arbitrary key projected by the projecting unit; and
a size of an outlined arbitrary key image area projected by the projecting unit.

8. An information processing device comprising:
a data input device including
a projecting unit that projects images of a plurality of keys; and
an instruction recognizing unit that recognizes whether any one of the images of the keys projected by the projecting unit has been designated by an operator;
a data input unit that accepts input of data corresponding to the image of the key recognized by the instruction recognizing unit; and
a controlling unit that controls any one of
a position, of a boundary between an image of an arbitrary key and an image of a key adjacent to the arbitrary key projected by the projecting unit;
a space between an instruction effective area of an image of an arbitrary key and an instruction effective area of an image of a key adjacent to the arbitrary key projected by the projecting unit; and
a size of an outlined arbitrary key image area projected by the projecting unit.

9. The information processing device according to claim 8, further comprising:
a correction data detecting unit that detects correction of the data recognized by the instruction recognizing unit; and
an analyzing unit that analyzes an input state of the operator based on detection results obtained by the correction detecting unit, wherein
the controlling unit controls any one of the position of the boundary, the space, and the size based on the results obtained by the correction detecting unit.

10. A data input method comprising:
projecting images of a plurality of keys;
recognizing whether any one of the images of the keys projected has been designated by an operator;
accepting input of data corresponding to the image of the key recognized; and
controlling any one of
a position of a boundary between an image of an arbitrary key and an image of a key adjacent to the arbitrary key projected;
a space between an instruction effective area of an image of an arbitrary key and an instruction effective area of an image of a key adjacent to the arbitrary key projected; and
a size of an outlined arbitrary key image area projected.

11. The data input method according to claim 10, further comprising:
detecting correction of the data recognized; and
analyzing an input state of the operator based on detection results obtained at the detecting, wherein
the controlling includes controlling any one of the position of the boundary, the space, and the size based on the results obtained at the detecting.

12. A computer program containing instructions which when executed on a computer causes the computer to execute:
projecting images of a plurality of keys;
recognizing whether any one of the images of the keys projected has been designated by an operator;
accepting input of data corresponding to the image of the key recognized; and
controlling any one of
a position of a boundary between an image of an arbitrary key and an image of a key adjacent to the arbitrary key projected;
a space between an instruction effective area of an image of an arbitrary key and an instruction effective area of an image of a key adjacent to the arbitrary key projected; and
a size of an outlined arbitrary key image area projected.

13. The computer program according to claim 12, further causes the computer to execute:
detecting correction of the data recognized; and
analyzing an input state of the operator based on detection results obtained at the detecting, wherein
the controlling includes controlling any one of the position of the boundary, the space, and the size based on the results obtained at the detecting.

14. A computer-readable recording medium that stores a computer program containing instructions which when executed on a computer causes the computer to execute:
projecting images of a plurality of keys;
recognizing whether any one of the images of the keys projected has been designated by an operator;
accepting input of data corresponding to the image of the key recognized; and
controlling any one of
a position of a boundary between an image of an arbitrary key and an image of a key adjacent to the arbitrary key projected;
a space between an instruction effective area of an image of an arbitrary key and an instruction effective area of an image of a key adjacent to the arbitrary key projected; and
a size of an outlined arbitrary key image area projected.
